(19) United States
(12) Patent Application Publication
(10) Pub. No.: US 2015/0121435 A1
(43) Pub. Date: Apr. 30, 2015

(54) METHOD AND APPARATUS FOR LOCAL DISTRIBUTION OF MULTIPLE MULTIMEDIA CHANNELS FROM MULTIMEDIA SERVICE PROVIDER

(71) Applicant: Alcatel-Lucent USA Inc., Murray Hill, NJ (US)

(72) Inventors: Shengqiang Wang, Cary, NC (US); Ranjan Sharma, New Albany, OH (US)

(73) Assignee: Alcatel-Lucent USA Inc., Murray Hill, NJ (US)

(21) Appl. No.: 14/063,730

(22) Filed: Oct. 25, 2013

(51) Int. Cl. H04N 21/81; H04N 21/439; H04N 21/472; H04N 21/41; H04N 21/422; H04N 21/4363; H04N 21/462

(52) U.S. Cl. CPC H04N 21/8113; H04N 21/43637; H04N 21/439; H04N 21/4622; H04N 21/4104; H04N 21/42204; H04N 21/472
USPC 725/81

(57) ABSTRACT

A set top box (STB) for local distribution of multiple multimedia channels from a multimedia service provider is provided. The STB includes a receiver, a multimedia signal processor, an audio signal processor, and a wireless transmitter. The user can access a plurality of multimedia channels carrying a multimedia signal with audio and video content. The receiver selects first and second multimedia channels for local distribution based on channel selection criteria. The STB distributes the first multimedia channel via a multimedia output path to a multimedia device. The STB distributes the second multimedia channel via an audio output path to an audio device. The wireless transmitter may include an FM transmitter. A media distribution unit for local distribution of multiple multimedia channels from a multimedia service provider and a method associated therewith are also provided.

### BACKGROUND

This disclosure relates to a structural unit at a customer premises between a multimedia service provider and multimedia and audio devices at the customer premises for local distribution of multiple multimedia channels from the multimedia service provider and methods associated therewith. For example, the structural unit may include a set top box (STB) with a wireless transmitter for distribution of a multimedia channel to a local radio receiver and other components for distribution of another multimedia channel to a local television (TV). Various embodiments of the methods and apparatus described herein may be used in conjunction with local distribution of multiple multimedia channels from a multimedia service provider to multimedia devices and audio devices in various combinations.

More and more high quality, hot hit music is delivered in today's Internet protocol TV (IPTV) network. However, these music IPTV channels can only be played on the TVs connected to the STBs. This limits the customer to the small room where they can hear the TV. The music delivered in the IPTV network cannot be received and played by radio receivers. There is no way for a customer to listen to the music delivered by IPTV network while working in the garage if there is no TV in the garage that is connected to the STB. In addition to music, there are a number of shows that audience can enjoy just by getting the audio section of the program. Finally, irrespective of the program content, the speakers in the TV present a problem in reproducing high-fidelity sound.

With reference to FIG. 1, in today's IPTV system 10, an STB 12 is connected to an IP network 14. Users can chose channels by operating the STB 12 which sends the channel request upstream to the IPTV network 14. IPTV network 14 delivers channel contents (IPTV signals) to the STB 12. The IPTV video/audio are played by a TV 16 connected to the STB 12.

In today's STB markets, some STBs come with frequency modulation (FM) receivers. In an existing STB arrangement, an FM transmitter is used in a home entertainment system in which the STB sends audio and video for a media channel to a TV and the FM transmitter sends the audio for the media channel to speakers that may be positioned at various locations around the room. See U.S. Pat. No. 7,610,013 to Suturdja for additional information on the home entertainment system. Suturdja also provides additional information on STB components, processing of multimedia, video, and audio signals within the STB, and control of the STB. The contents of U.S. Pat. No. 7,610,013 to Suturdja are fully incorporated herein by reference.

There is no good solution for the above stated problems. In some cases, the problem is alleviated by using a setup that handles the sound separately (e.g., using home theater system that handles the sound from the TV), but for the scenario mentioned above, that too falls short because the STB is typically connected to one TV and the audience can be working at a distance from the TV. Raising the volume of the sound may seem like an obvious solution, but it is not practical in many cases.

For these and other reasons, there is a need to define a STB or a similar structural unit that can distribute a multimedia channel to a TV and the audio for another multimedia channel to a radio receiver.

### SUMMARY

In one aspect, an STB for local distribution of multiple multimedia channels from a multimedia service provider is provided. In one embodiment, the STB includes: a receiver configured for access to a plurality of multimedia channels offered by a multimedia service provider from a customer premises via an access network, each multimedia channel carrying a multimedia signal with audio and video content, wherein the receiver is configured to select first and second multimedia channels from the plurality of multimedia channels for local distribution at the customer premises based on channel selection criteria, wherein the STB is configured to distribute the first multimedia channel via one or more multimedia output path and the second multimedia channel via one or more audio output path based on output selection criteria; a multimedia signal processor configured to receive first and second multimedia signals corresponding to the first and second multimedia channels from the receiver, to demodulate modulated portions of each of the first and second multimedia signals, to decode encoded portions of each of the first and second multimedia signals, and to separate the audio and video content of each of the first and second multimedia signals to form corresponding first and second audio signals and first and second video signals; an audio signal processor configured to receive the first and second audio signals from the multimedia signal processor and to condition each of the first and second audio signals to form corresponding first and second conditioned audio signals; and a wireless transmitter configured to receive the second conditioned audio signal based on the output selection criteria, to perform at least one of modulating and encoding of the second conditioned audio signal to form a corresponding second audio transmission signal, and to wirelessly transmit the second audio transmission signal via at least one select output path of the one or more audio output path based on the output selection criteria.

In another aspect, an apparatus for local distribution of multiple multimedia channels from a multimedia service provider is provided. In one embodiment, the apparatus includes: a receiver configured for access to a plurality of multimedia channels offered by a multimedia service provider from a customer premises via an access network, each multimedia channel carrying a multimedia signal with audio and video content, wherein the receiver is configured to select multiple multimedia channels from the plurality of multimedia channels for local distribution at the customer premises based on channel selection criteria, wherein the apparatus is configured to distribute the multiple multimedia channels via one or more multimedia output path and one or more audio output path in any combination based on output selection criteria; a multimedia signal processor configured to receive multiple multimedia signals corresponding to the multiple multimedia channels from the receiver, to demodulate modulated portions of each of the multiple multimedia signals, to decode encoded portions of each of the multiple multimedia signals, and to separate the audio and video content of each of the multiple multimedia signals to form corresponding audio and video signals; an audio signal processor configured to receive the audio signal for each of the multiple multimedia channels from the multimedia signal processor and to condition each audio signal to form a corresponding conditioned audio signal; and a wireless transmitter configured to receive the conditioned audio signal for one or more select multimedia channel of the multiple multimedia channels based on the output selection criteria, to perform at least one of modulating and encoding of the conditioned audio signal for each select multimedia channel to form a corresponding audio transmission signal, and to wirelessly transmit each audio transmission signal via at least one select output path of the one or more audio output path based on the output selection criteria.

In yet another aspect, a method for local distribution of multiple multimedia channels from a multimedia service provider is provided. In one embodiment, the method includes: selecting multiple multimedia channels from a plurality of multimedia channels for local distribution at a customer premises based on channel selection criteria, each multimedia channel carrying a multimedia signal with audio and video content, wherein the plurality of multimedia channels are offered by a multimedia service provider; receiving multiple multimedia signals from the multimedia service provider at a receiver of an apparatus within the customer premises via an access network, wherein the received multiple multimedia signals correspond to the selected multiple multimedia channels, wherein the apparatus is configured to distribute the multiple multimedia channels via one or more multimedia output path and one or more audio output path in any combination based on output selection criteria; processing the multiple multimedia signals to demodulate modulated portions of each of the multiple multimedia signals, to decode encoded portions of each of the multiple multimedia signals, and to separate the audio and video content of each of the multiple multimedia signals to form corresponding audio and video signals; processing the audio signal for each of the multiple multimedia channels to condition each audio signal to form a corresponding conditioned audio signal; receiving the conditioned audio signal for one or more select multimedia channel of the multiple multimedia channels at a wireless transmitter based on the output selection criteria; performing at least one of modulating and encoding of the conditioned audio signal for each select multimedia channel to form a corresponding audio transmission signal; and wirelessly transmitting each audio transmission signal from the wireless transmitter via at least one select output path of the one or more audio output path based on the output selection criteria.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an existing IPTV system for delivery of a multimedia content to a TV at a customer premises;

FIG. 2 is a block diagram of an exemplary embodiment of an IPTV system for delivery of multimedia content to a TV at a customer premises and audio content to a radio at the customer premises;

FIG. 3 is a block diagram of an exemplary embodiment of a STB for local distribution of multiple multimedia channels from a multimedia service provider;

FIG. 4 is a block diagram of an exemplary embodiment of a media distribution unit for local distribution of multiple multimedia channels from a multimedia service provider;

FIG. 5 is a flow chart of an exemplary embodiment of a process for local distribution of multiple multimedia channels from a multimedia service provider; and

FIG. 6, in conjunction with FIG. 5, is a flow chart of another exemplary embodiment of a process for local distribution of multiple multimedia channels from a multimedia service provider.

### DETAILED DESCRIPTION

This disclosure, for example, presents various embodiments of apparatus and methods for distributing multiple multimedia channels from a multimedia service provider to multimedia and audio devices within a customer premises. The structural elements between the multimedia service provider and multimedia and audio devices that accomplish selection and distribution multiple media channels are located at the customer premises. In particular, the various apparatus and methods permit a multimedia channel to be distributed to a multimedia device and a different multimedia channel to be distributed to an audio device.

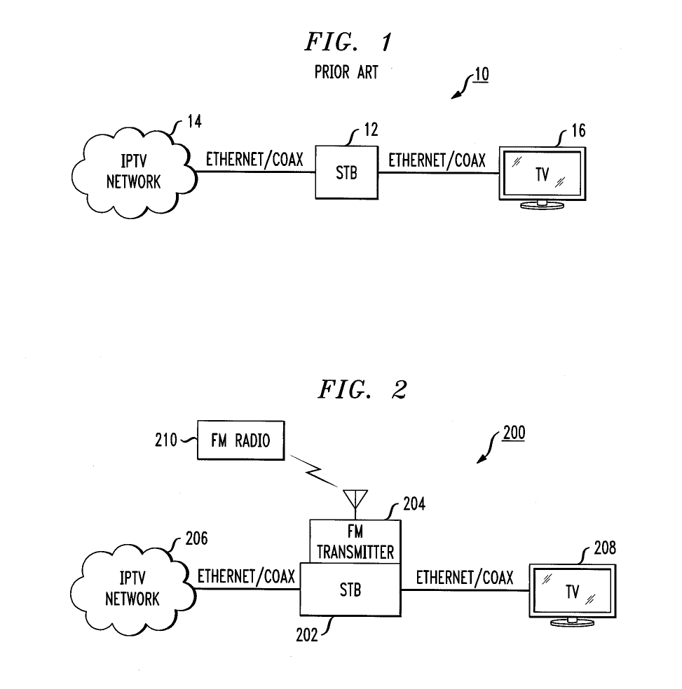

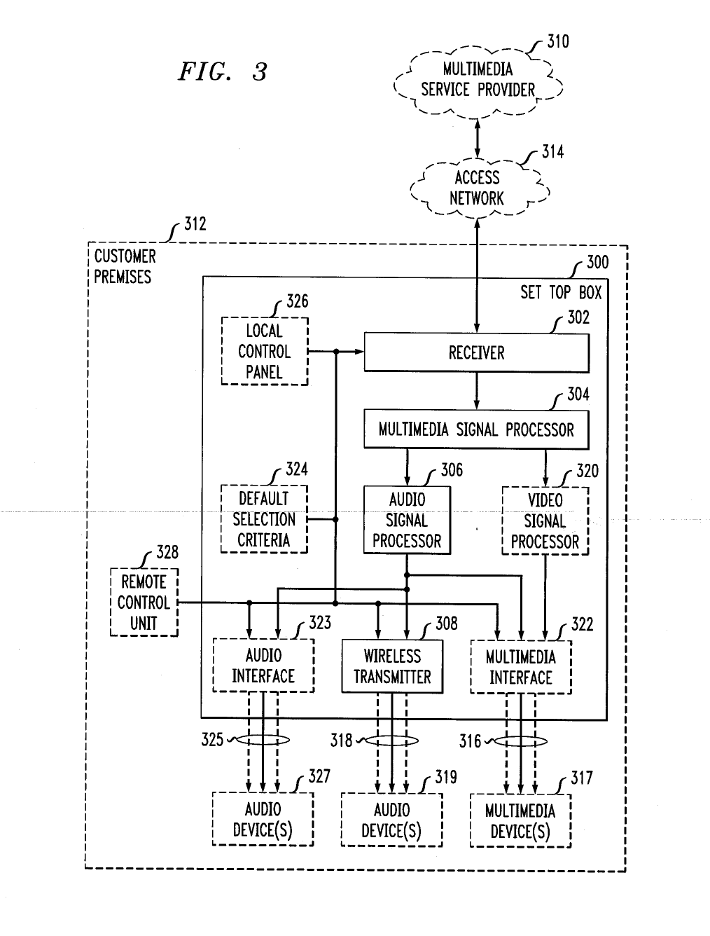

With reference to FIG. 2, an exemplary embodiment of an IPTV system 200 may include a STB 202 with an FM transmitter 204 that distributes multiple multimedia channels from an IPTV network 206 to a TV 208 and an FM radio 210. The FM transmitter 204 can be an add-on to the STB 202 in that it can tap an audio signal that originates from a multimedia signal for a multimedia channel and transmit the corresponding audio for the multimedia channel to the FM radio 210. For dual or multi-channel STBs, a multimedia channel selected for audio reception at the FM radio 210 can be different from the multimedia channel selected for multimedia reception at the TV 208.

For example, users can chose a music channel on the STB 202 in a normal way. In addition to selecting the channel, users can also chose an FM frequency for the STB 202 to use to generate and transmit the FM signal. This can be done using buttons on the STB 202 or on a remote control for the STB 202. After these operations, users can use FM radio receivers 210 anywhere around the house to listen to the music delivered from the IPTV network 206 by the STB 202.

For STBs 202 that are capable of dual-channel or multi-channel reception (such as those that can feed more than one TV 208 via employing dual-tuner or multi-tuner), it is possible for the STB 202 to catch more than one channel at a time, which makes it possible for the audience at the TV 208 to enjoy one show, while another audience segment can tune into a talk-show or music channel and get it at nearby FM radio receivers 210 via the FM transmitter 204 embedded in the STB 202.

Several exemplary case scenarios are described to help explain operation of the STB and FM transmitter. In one scenario, the user uses remote control for the STB to choose a music channel. The music channel could be played on the TV, but it is not necessary. In another scenario, if the user desires to listen to the music channel using a radio receiver in the garage, the user uses buttons on the STB or on the remote control for the STB to enable the FM modulator function on the STB and selects an FM frequency. The FM frequency may appear on a panel display for the STB. The user can then walk to the garage and turn on the radio receiver. The user can tune the radio receiver to the same FM frequency that was selected on the STB. After the radio receiver is tuned to the frequency selected for the FM Transmitter, music delivered to the STB and selected for output from the FM Transmitter is played on the radio receiver.

STBs equipped with a single tuner can receive a single channel at a time. Dual-tuners are required for simultaneous reception of two channels. For example, one channel can be an IPTV feed for a TV program and another channel could be an IPTV feed for a music channel. The audio can for the music channel can be transmitted from the STB by the FM transmitter for reception by a standard FM radio receiver within range of the transmitter. Obviously, FCC regulations for transmitter power by the FM transmitter must be observed so the range is expected to be within the customer premises for the STB.

In other embodiment, alternatives to the FM transmitter include a Bluetooth transmitter, a WiFi transmitter, or similar wireless transmitters suitable and configured to transmit an audio stream. For example, the wireless transmitters and receivers can be equipped with an “airplay” capability to set up and control transmissions for the audio stream. However, use of low power FM transmission allows for an easier implementation for local areas. For example, FM radio transmitters with limited range are currently available and FM radio receivers are almost ubiquitous.

Users can choose to use FM radio receivers that are used for listening to FM radio stations to listen to the music delivered by IPTV network through the STB via the FM transmitter. This also makes providing the extended audio (e.g., music) service attractive to the IPTV service provider and the STB manufacturer.

In other embodiments, the STB can receive multimedia channels from any multimedia service provider. For example, cable TV service providers, satellite TV service providers, or broadcast TV service providers as well as IPTV service providers. Similarly, in other embodiments, the STB can be any form of a media distribution box at a customer premises that can suitably interface with a multimedia service provider for receiving multimedia channels and distribute audio and video signals for one channel to a TV or similar multimedia device and distribute an audio signal for another channel via wireless transmission to audio device(s) within range of the transmission. As mentioned above, the audio devices are expected to be at or near the customer premises because the transmission is low power and fairly short range. The wireless transmission can be regulated so that multimedia or audio devices operated by non-subscribers (e.g., neighbors) cannot catch programs without paying subscription or membership fees.

With reference to FIG. 3, an exemplary embodiment of a STB 300 for local distribution of multiple multimedia channels from a multimedia service provider includes a receiver 302, a multimedia signal processor 304, an audio signal processor 306, and a wireless transmitter 308. The receiver 302 configured for access to a plurality of multimedia channels offered by a multimedia service provider 310 from a customer premises 312 via an access network 314. Each multimedia channel carrying a multimedia signal with audio and video content. The receiver 302 is configured to select first and second multimedia channels from the plurality of multimedia channels for local distribution at the customer premises 312 based on channel selection criteria. The STB 300 is configured to distribute the first multimedia channel via one or more multimedia output path 316 to one or more multimedia device 317 and the second multimedia channel via one or more audio output path 318 to one or more audio device 319 based on output selection criteria.

The multimedia signal processor 304 configured to receive first and second multimedia signals corresponding to the first and second multimedia channels from the receiver 302. The multimedia signal processor 304 configured to demodulate modulated portions of each of the first and second multimedia signals. The multimedia signal processor 304 configured to decode encoded portions of each of the first and second multimedia signals. The multimedia signal processor 304 configured to separate the audio and video content of each of the first and second multimedia signals to form corresponding first and second audio signals and first and second video signals. The audio signal processor 306 configured to receive the first and second audio signals from the multimedia signal processor 306. The audio signal processor 306 configured to condition each of the first and second audio signals to form corresponding first and second conditioned audio signals.

The wireless transmitter 308 configured to receive the second conditioned audio signal from the audio signal processor 306 based on the output selection criteria. The wireless transmitter 308 configured to perform at least one of modulating and encoding of the second conditioned audio signal to form a corresponding second audio transmission signal. The wireless transmitter 308 configured to wirelessly transmit the second audio transmission signal via at least one select output path of the one or more audio output path 318 based on the output selection criteria.

In another embodiment, the STB 300 also includes a video signal processor 320 and a multimedia interface 322. The video signal processor 320 configured to receive the first video signal from the multimedia signal processor 304. The video signal processor 320 configured to condition the first video signal to form a corresponding first conditioned video signal. The multimedia interface 322 configured to receive the first conditioned audio signal from the audio signal processor 306 and the first conditioned video signal from the video signal processor 320 based on the output selection criteria. The multimedia interface 322 configured to distribute the first conditioned audio signal and the first conditioned video signal via at least one preselected output path of the one or more multimedia output path 316 based on the output selection criteria.

In another embodiment, the STB 300 also includes an audio interface 323. The audio interface 323 configured to receive a conditioned audio signal from the audio signal processor 306 based on channel and output selection criteria. The audio interface 323 configured to distribute the conditioned audio signal via at least one preselected output path of one or more wired audio output path 325 based on the output selection criteria. Depending on the channel selection criteria, the audio interface 323 may receive conditioned audio for the same channel as the multimedia interface 322, conditioned audio the same channel as the wireless transmitter 308, or conditioned audio for a third channel different from the other channels. The output path(s) 325 may connect the audio interface 323 to audio device(s) 327 via USB cables, serial cables, parallel cables, data cables, coaxial cables, triaxial cables, twisted pair, speaker cables, or any suitable arrangement of wired connections.

In yet another embodiment of the STB 300, the multimedia service provider 310 requires a service account for access to the plurality of multimedia channels. In this embodiment, the receiver 302 is configured to authenticate that the service account is in good standing and authorized to distribute each of the first and second multimedia channels at the customer premises 312.

In still another embodiment of the STB 300, the plurality of multimedia channels are provided by a cable TV service provider, a satellite TV service provider, an IPTV service provider, an Internet service provider, a broadcast TV station, or any suitable multimedia service provider in any suitable combination.

In still yet another embodiment of the STB 300, the access network 314 includes a cable TV network, a satellite TV network, a broadcast TV network, a public switched telephone network (PSTN), a mobile telephone network, a WiMAX network, an Ethernet network, a WiFi network, a metropolitan area network (MAN), a wide area network (WAN), an Internet area network (IAN), or any suitable access network in any suitable combination.

In another embodiment of the STB 300, the channel selection criteria includes default selection criteria 324, user settings, or any suitable combination thereof. In this embodiment, the user settings are based on user activation of channel selection controls on a local control panel 326 or a remote control unit 328.

In yet another embodiment of the STB 300, the output selection criteria includes default selection criteria 324, user settings, or any suitable combination thereof. In this embodiment, the user settings are based on user activation of output selection controls on the local control panel 326 or the remote control unit 328.

In still another embodiment of the STB 300, the wireless transmitter 308 includes an FM transmitter configured to transmit the second audio transmission signal. In this embodiment, each select output path 318 is defined by an FM carrier frequency. In the embodiment being described, the output selection criteria identifies the FM carrier frequency for each select output path 318.

In still yet another embodiment of the STB 300, the wireless transmitter 308 includes a Bluetooth transmitter configured to transmit the second audio transmission signal. In this embodiment, each select output path 318 is defined by at least one destination address. In the embodiment being described, the output selection criteria identifies the at least one destination address for each select output path 318.

In another embodiment of the STB 300, the wireless transmitter 308 includes a WiFi transmitter configured to transmit the second audio transmission signal. In this embodiment, each select output path 318 is defined by at least one destination address. In the embodiment being described, the output selection criteria identifies the at least one destination address for each select output path 318.

In yet another embodiment of the STB 300, the wireless transmitter 308 is configured to transmit the second audio transmission signal via a transmission mode that includes a broadcast mode, a multicast mode, or a unicast mode in any suitable combination. In the broadcast mode, the second audio transmission signal is transmitted to compatible audio receiving devices within range of the wireless transmitter 308. In the multicast mode, the second audio transmission signal is transmitted to a group of local audio receiving devices. In the unicast mode, the second audio transmission signal is transmitted to a select local audio receiving device. In this embodiment, the output selection criteria identifies the transmission mode for each select output path 318.

In still another embodiment of the STB 300, the wireless transmitter 308 is configured to transmit the second audio transmission signal via a transmission mode that includes a streaming audio mode, an AirPlay mode, an AirPlay Mirroring mode, an AirTunes mode, or a Play To mode in any suitable combination to one or more compatible audio receiving devices within range of the wireless transmitter 308. The AirPlay, AirPlay Mirroring, and AirTunes modes are compatible with corresponding applications introduced by Apple, Inc. of Cupertino, CA. The Play To mode is compatible with a corresponding application introduced by Microsoft, Inc. of Redmond, WA. In this embodiment, the output selection criteria identifies the transmission mode for each select output path 318.

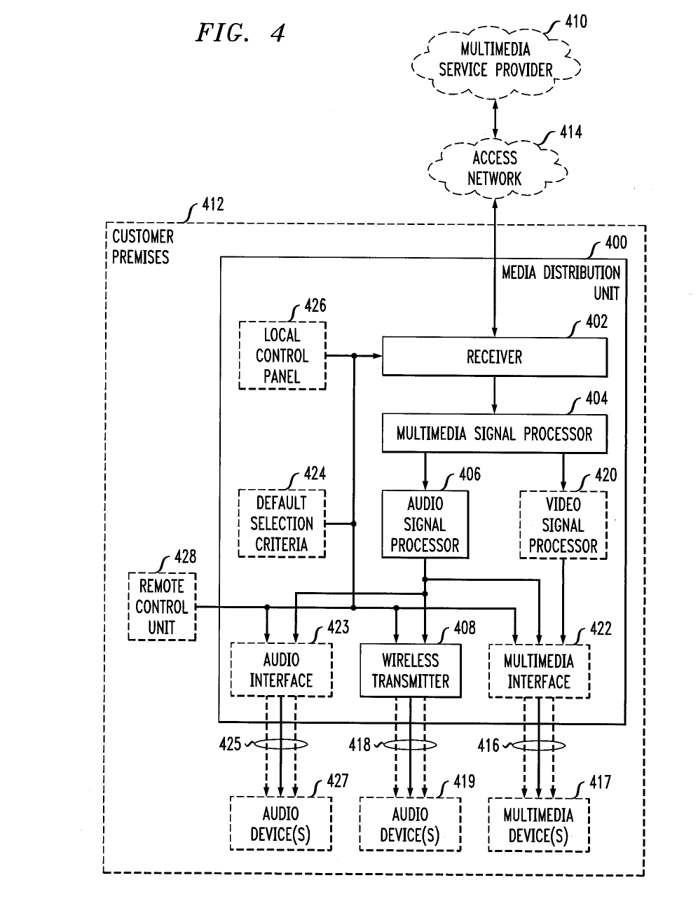

With reference to FIG. 4 an exemplary embodiment of a media distribution unit 400 for local distribution of multiple multimedia channels from a multimedia service provider includes a receiver 402, a multimedia signal processor 404, an audio signal processor 406, and a wireless transmitter 408. The receiver 402 configured for access to a plurality of multimedia channels offered by a multimedia service provider 410 from a customer premises 412 via an access network 414. Each multimedia channel carrying a multimedia signal with audio and video content. The receiver 402 is configured to select multiple multimedia channels from the plurality of multimedia channels for local distribution at the customer premises 412 based on channel selection criteria. The media distribution unit 400 is configured to distribute the multiple multimedia channels via one or more multimedia output path 416 to one or more multimedia device 417 and one or more audio output path 418 to one or more audio device 419 in any combination based on output selection criteria.

The multimedia signal processor 404 configured to receive multiple multimedia signals corresponding to the multiple multimedia channels from the receiver 402. The multimedia signal processor 404 configured to demodulate modulated portions of each of the multiple multimedia signals. The multimedia signal processor 404 configured to decode encoded portions of each of the multiple multimedia signals. The multimedia signal processor 404 configured to separate the audio and video content of each of the multiple multimedia signals to form corresponding audio and video signals. The audio signal processor 406 configured to receive the audio signal for each of the multiple multimedia channels from the multimedia signal processor 404. The audio signal processor 406 configured to condition each audio signal to form a corresponding conditioned audio signal.

The wireless transmitter 408 configured to receive the conditioned audio signal for one or more select multimedia channel of the multiple multimedia channels from the audio signal processor 406 based on the output selection criteria. The wireless transmitter 408 configured to perform at least one of modulating and encoding of the conditioned audio signal for each select multimedia channel to form a corresponding audio transmission signal. The wireless transmitter 408 configured to wirelessly transmit each audio transmission signal via at least one select output path of the one or more audio output path 418 based on the output selection criteria.

In another embodiment of the media distribution unit 400, the receiver 402, multimedia signal processor 404, audio signal processor 406, and wireless transmitter 408 are combined in an STB, a set top unit, a digibox, a net top box, a converter box, a cable TV box, an IPTV box, a satellite TV receiver, or any suitable media distribution unit.

In yet another embodiment of the media distribution unit 400, at least one select multimedia channel distributed via the one or more audio output path 419 is not distributed via the one or more video output path 417.

In still another embodiment of the media distribution unit 400, the output selection criteria relates the multiple multimedia channels to the multimedia and audio output paths 417, 419 and defines the combination for each of the multiple multimedia channels

In still yet another embodiment, the media distribution unit 400 also includes a video signal processor 420 and a multimedia interface 422. The video signal processor 420 configured to receive the video signal for each of the multiple multimedia channels from the multimedia signal processor 404. The video signal processor 420 configured to condition each video signal to form a corresponding conditioned video signal. The multimedia interface 422 configured to receive the conditioned audio and video signals for one or more preselected multimedia channel of the multiple multimedia channels from the audio and video signal processors 406, 420 based on the output selection criteria. The multimedia interface 422 configured to distribute the conditioned audio and video signals for each preselected multimedia channel via at least one preselected output path of the one or more multimedia output path 417 based on the output selection criteria.

In another embodiment, the media distribution unit 400 also includes an audio interface 423. The audio interface 423 configured to receive a conditioned audio signal from the audio signal processor 406 based on channel and output selection criteria. The audio interface 423 configured to distribute the conditioned audio signal via at least one preselected output path of one or more wired audio output path 425 based on the output selection criteria. Depending on the channel selection criteria, the audio interface 423 may receive conditioned audio for the same channel as the multimedia interface 422, conditioned audio the same channel as the wireless transmitter 408, or conditioned audio for a third channel different from the other channels. The output path(s) 425 may connect the audio interface 423 to audio device(s) 427 via USB cables, serial cables, parallel cables, data cables, coaxial cables, triaxial cables, twisted pair, speaker cables, or any suitable arrangement of wired connections.

In another embodiment of the media distribution unit 400, the multimedia service provider 410 requires a service account for access to the plurality of multimedia channels. In this embodiment, the receiver 402 is configured to authenticate that the service account is in good standing and authorized to distribute each of the multiple multimedia channels at the customer premises 412.

In yet another embodiment of the media distribution unit 400, the plurality of multimedia channels are provided by a cable TV service provider, a satellite TV service provider, an IPTV service provider, an Internet service provider, a broadcast TV station, or any suitable multimedia service provider in any suitable combination.

In still another embodiment of the media distribution unit 400, the access network 414 includes a cable TV network, a satellite TV network, a broadcast TV network, a PSTN, a mobile telephone network, a WiMAX network, an Ethernet network, a WiFi network, a MAN, a WAN, an IAN, or any suitable access network in any suitable combination.

In still yet another embodiment of the media distribution unit 400, the channel selection criteria includes default selection criteria 424, user settings, or any suitable combination thereof. In this embodiment, the user settings are based on user activation of channel selection controls on a local control panel 426 or a remote control unit 428.

In another embodiment of the media distribution unit 400, the output selection criteria includes default selection criteria 424, user settings, or any suitable combination thereof. In this embodiment, the user settings are based on user activation of output selection controls on a local control panel 426 or a remote control unit 428.

In yet another embodiment of the media distribution unit 400, the wireless transmitter 408 includes an FM transmitter configured to transmit the audio transmission signal for at least one select multimedia channel. In this embodiment, each select output path 418 for each multimedia channel transmitted by the FM transmitter is defined by an FM carrier frequency. In the embodiment being described, the output selection criteria identifies the FM carrier frequency for each select output path 418 used by the FM transmitter.

In still another embodiment of the media distribution unit 400, the wireless transmitter 408 includes a Bluetooth transmitter configured to transmit the audio transmission signal for at least one select multimedia channel. In this embodiment, each select output path 418 for each multimedia channel transmitted by the Bluetooth transmitter is defined by at least one destination address. In the embodiment being described, the output selection criteria identifies the at least one destination address for each select output path 418 used by the Bluetooth transmitter.

In still yet another embodiment of the media distribution unit 400, the wireless transmitter 408 includes a WiFi transmitter configured to transmit the audio transmission signal for at least one select multimedia channel. In this embodiment, each select output path 418 for each multimedia channel transmitted by the WiFi transmitter is defined by at least one destination address. In the embodiment being described, the output selection criteria identifies the at least one destination address for each select output path 418 used by the WiFi transmitter.

In another embodiment of the media distribution unit 400, the wireless transmitter 408 is configured to transmit the audio transmission signal for each one or more select multimedia channel via a transmission mode that includes a broadcast mode, a multicast mode, or a unicast mode in any suitable combination. In the broadcast mode, the audio transmission signal for each one or more select multimedia channel is transmitted to compatible audio receiving devices within range of the wireless transmitter. In the multicast mode, the audio transmission signal for each one or more select multimedia channel is transmitted to a group of local audio receiving devices. In the unicast mode the audio transmission signal for each one or more select multimedia channel is transmitted to a select local audio receiving device. In this embodiment, the output selection criteria identifies the transmission mode for each select output path 418.

In yet another embodiment of the media distribution unit 400, the wireless transmitter 408 is configured to transmit the audio transmission signal for each one or more select multimedia channel via a transmission mode that includes a streaming audio mode, an AirPlay mode, an AirPlay Mirroring mode, an AirTunes mode, or a Play To mode in any suitable combination to one or more compatible audio receiving devices within range of the wireless transmitter 408. The AirPlay, AirPlay Mirroring, and AirTunes modes are compatible with corresponding applications introduced by Apple, Inc. of Cupertino, CA. The Play To mode is compatible with a corresponding application introduced by Microsoft, Inc. of Redmond, WA. In this embodiment, the output selection criteria identifies the transmission mode for each select output path 418.

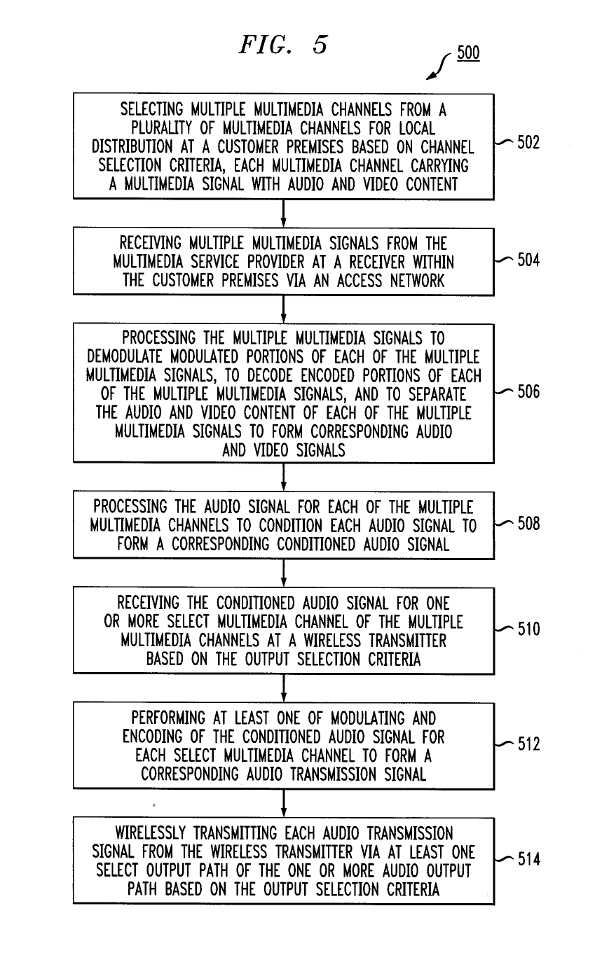

With reference to FIG. 5, an exemplary embodiment of a process 500 for local distribution of multiple multimedia channels from a multimedia service provider begins at 502 where multiple multimedia channels are selected from a plurality of multimedia channels for local distribution at a customer premises based on channel selection criteria. Each multimedia channel carrying a multimedia signal with audio and video content. The plurality of multimedia channels are offered by a multimedia service provider. At 504, multiple multimedia signals are received from the multimedia service provider at a receiver of an apparatus within the customer premises via an access network. The received multiple multimedia signals correspond to the selected multiple multimedia channels. The apparatus is configured to distribute the multiple multimedia channels via one or more multimedia output path and one or more audio output path in any combination based on output selection criteria.

Next, the multiple multimedia signals are processed to demodulate modulated portions of each of the multiple multimedia signals, to decode encoded portions of each of the multiple multimedia signals, and to separate the audio and video content of each of the multiple multimedia signals to form corresponding audio and video signals (506). At 508, the audio signal for each of the multiple multimedia channels is processed to condition each audio signal to form a corresponding conditioned audio signal.

Next, the conditioned audio signal for one or more select multimedia channel of the multiple multimedia channels is received at a wireless transmitter based on the output selection criteria (510). At 512, at least one of modulating and encoding of the conditioned audio signal is performed for each select multimedia channel to form a corresponding audio transmission signal. Next, each audio transmission signal is wirelessly transmitted from the wireless transmitter via at least one select output path of the one or more audio output path based on the output selection criteria (514).

In another embodiment of the process 500, the receiver and wireless transmitter are combined in an STB, a set top unit, a digibox, a net top box, a converter box, a cable TV box, an IPTV box, a satellite TV receiver, or any suitable apparatus.

In yet another embodiment of the process 500, at least one select multimedia channel distributed via the one or more audio output path is not distributed via the one or more video output path.

In still another embodiment of the process 500, the output selection criteria relates the multiple multimedia channels to the multimedia and audio output paths and defines the combination for each of the multiple multimedia channels.

In still yet another embodiment of the process 500, the multimedia service provider requires a service account for access to the plurality of multimedia channels. In this embodiment, the process 500 also includes authenticating that the service account is in good standing and authorized to distribute each of the multiple multimedia channels at the customer premises.

In another embodiment of the process 500, the plurality of multimedia channels are provided by a cable TV service provider, a satellite TV service provider, an IPTV service provider, an Internet service provider, a broadcast TV station, or any suitable multimedia service provider in any suitable combination.

In yet another embodiment of the process 500, the access network includes a cable TV network, a satellite TV network, a broadcast TV network, a PSTN, a mobile telephone network, a WiMAX network, an Ethernet network, a WiFi network, a MAN, a WAN, an IAN, or any suitable access network in any suitable combination.

In still another embodiment of the process 500, the channel selection criteria includes default selection criteria, user settings, or any suitable combination thereof. In this embodiment, the user settings are based on user activation of channel selection controls on a local control panel or a remote control unit.

In still yet another embodiment of the process 500, the output selection criteria includes default selection criteria, user settings, or any suitable combination thereof. In this embodiment, the user settings are based on user activation of output selection controls on a local control panel or a remote control unit.

In another embodiment of the process 500, the wireless transmitter includes an FM transmitter. In this embodiment, the process 500 also includes transmitting the audio transmission signal for at least one select multimedia channel from the FM transmitter. In the embodiment being described, each select output path for each multimedia channel transmitted by the FM transmitter is defined by an FM carrier frequency. In this embodiment, the output selection criteria identifies the FM carrier frequency for each select output path used by the FM transmitter.

In yet another embodiment of the process 500, the wireless transmitter includes a Bluetooth transmitter. In this embodiment, the process 500 also includes transmitting the audio transmission signal for at least one select multimedia channel from the Bluetooth transmitter. In the embodiment being described, each select output path for each multimedia channel transmitted by the Bluetooth transmitter is defined by at least one destination address. In this embodiment, the output selection criteria identifies the at least one destination address for each select output path used by the Bluetooth transmitter.

In still another embodiment of the process 500, the wireless transmitter includes a WiFi transmitter. In this embodiment, the process also includes transmitting the audio transmission signal for at least one select multimedia channel from the WiFi transmitter. In the embodiment being described, each select output path for each multimedia channel transmitted by the WiFi transmitter is defined by at least one destination address. In this embodiment, the output selection criteria identifies the at least one destination address for each select output path used by the WiFi transmitter.

In still yet another embodiment, the process 500 also includes transmitting the audio transmission signal for each one or more select multimedia channel from the wireless transmitter via a transmission mode that includes a broadcast mode, a multicast mode, or a unicast mode in any suitable combination. In the broadcast mode, the audio transmission signal for each one or more select multimedia channel is transmitted to compatible audio receiving devices within range of the wireless transmitter. In the multicast mode, the audio transmission signal for each one or more select multimedia channel is transmitted to a group of local audio receiving devices. In the unicast mode, the audio transmission signal for each one or more select multimedia channel is transmitted to a select local audio receiving device. In this embodiment, the output selection criteria identifies the transmission mode for each select output path.

In another embodiment, the process 500 also includes transmitting the audio transmission signal for each one or more select multimedia channel from the wireless transmitter via a transmission mode that includes a streaming audio mode, an AirPlay mode, an AirPlay Mirroring mode, an AirTunes mode, and a Play To mode in any combination to one or more compatible audio receiving devices within range of the wireless transmitter. The AirPlay, AirPlay Mirroring, and AirTunes modes are compatible with corresponding applications introduced by Apple, Inc. of Cupertino, Calif. The Play To mode is compatible with a corresponding application introduced by Microsoft, Inc. of Redmond, WA. In this embodiment, the output selection criteria identifies the transmission mode for each select output path.

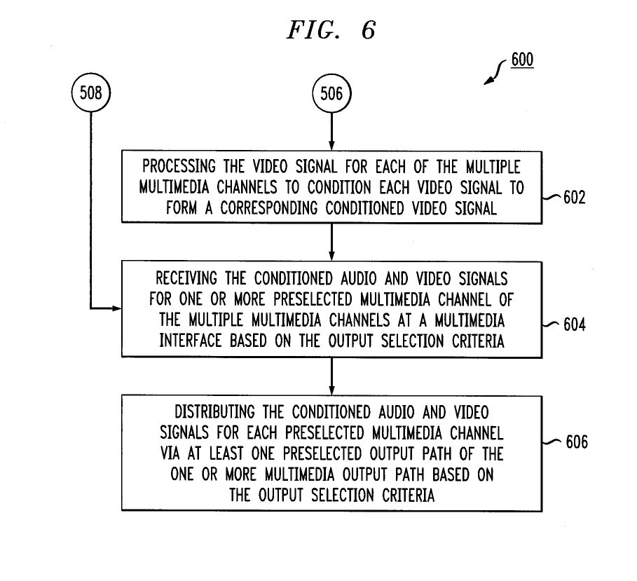

With reference to FIGS. 5 and 6, another exemplary embodiment of a process 600 for local distribution of multiple multimedia channels from a multimedia service provider includes the process 500 of FIG. 5 and continues from 506 and 508. In this embodiment of the process 600 continues from 506 by processing the video signal for each of the multiple multimedia channels to condition each video signal to form a corresponding conditioned video signal (602). At 604, the conditioned audio and video signals for one or more preselected multimedia channel of the multiple multimedia channels from 508 and 602 are received at a multimedia interface based on the output selection criteria. Next, the conditioned audio and video signals for each preselected multimedia channel are distributed via at least one preselected output path of the one or more multimedia output path based on the output selection criteria (606).

In another embodiment, the process 500, 600 also includes receiving the conditioned audio for one or more preselected multimedia channel of the multiple multimedia channels from 508 at an audio interface based on channel and output selection criteria. Next, the conditioned audio for each preselected multimedia channel is distributed via at least one preselected output path of the one or more wired audio output path based on the output selection criteria. Depending on the channel selection criteria, the audio interface may receive conditioned audio for the same channel as the multimedia interface, conditioned audio the same channel as the wireless transmitter, or conditioned audio for a third channel different from the other channels. The output path(s) may connect the audio interface to audio device(s) via USB cables, serial cables, parallel cables, data cables, coaxial cables, triaxial cables, twisted pair, speaker cables, or any suitable arrangement of wired connections.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A set top box (STB) for local distribution of multiple multimedia channels from a multimedia service provider, the STB comprising:
a receiver configured for access to a plurality of multimedia channels offered by a multimedia service provider from a customer premises via an access network, each multimedia channel carrying a multimedia signal with audio and video content, wherein the receiver is configured to select first and second multimedia channels from the plurality of multimedia channels for local distribution at the customer premises based on channel selection criteria, wherein the STB is configured to distribute the first multimedia channel via one or more multimedia output path and the second multimedia channel via one or more audio output path based on output selection criteria;
a multimedia signal processor configured to receive first and second multimedia signals corresponding to the first and second multimedia channels from the receiver, to demodulate modulated portions of each of the first and second multimedia signals, to decode encoded portions of each of the first and second multimedia signals, and to separate the audio and video content of each of the first and second multimedia signals to form corresponding first and second audio signals and first and second video signals;
an audio signal processor configured to receive the first and second audio signals from the multimedia signal processor and to condition each of the first and second audio signals to form corresponding first and second conditioned audio signals; and
a wireless transmitter configured to receive the second conditioned audio signal based on the output selection criteria, to perform at least one of modulating and encoding of the second conditioned audio signal to form a corresponding second audio transmission signal, and to wirelessly transmit the second audio transmission signal via at least one select output path of the one or more audio output path based on the output selection criteria.

2. The apparatus of claim 1, further comprising:
a video signal processor configured to receive the first video signal from the multimedia signal processor and to condition the first video signal to form a corresponding first conditioned video signal; and
a multimedia interface configured to receive the first conditioned audio signal from the audio signal processor and the first conditioned video signal from the video signal processor based on the output selection criteria and to distribute the first conditioned audio signal and the first conditioned video signal via at least one preselected output path of the one or more multimedia output path based on the output selection criteria.

3. The apparatus of claim 1 wherein the plurality of multimedia channels are provided by at least one of a cable television (TV) service provider, a satellite TV service provider, an internet protocol TV (IPTV) service provider, an Internet service provider, and a broadcast TV station;
wherein the access network includes at least one of a cable television (TV) network, a satellite TV network, a broadcast TV network, a public switched telephone network (PSTN), a mobile telephone network, a WiMAX network, an Ethernet network, a WiFi network, a metropolitan area network (MAN), a wide area network (WAN), and an Internet area network (IAN).

4. The apparatus of claim 1 wherein the channel selection criteria includes at least one of default selection criteria and user settings, wherein the user settings are based on user activation of channel selection controls on a local control panel or a remote control unit;
wherein the output selection criteria includes at least one of default selection criteria and user settings, wherein the user settings are based on user activation of output selection controls on a local control panel or a remote control unit.

5. The apparatus of claim 1 wherein the wireless transmitter includes a frequency modulation (FM) transmitter configured to transmit the second audio transmission signal, wherein each select output path is defined by an FM carrier frequency, wherein the output selection criteria identifies the FM carrier frequency for each select output path.

6. The apparatus of claim 1 wherein the wireless transmitter includes at least one of a Bluetooth transmitter and a WiFi transmitter configured to transmit the second audio transmission signal, wherein each select output path is defined by at least one destination address, wherein the output selection criteria identifies the at least one destination address for each select output path.

7. An apparatus for local distribution of multiple multimedia channels from a multimedia service provider, the apparatus comprising:
a receiver configured for access to a plurality of multimedia channels offered by a multimedia service provider from a customer premises via an access network, each multimedia channel carrying a multimedia signal with audio and video content, wherein the receiver is configured to select multiple multimedia channels from the plurality of multimedia channels for local distribution at the customer premises based on channel selection criteria, wherein the apparatus is configured to distribute the multiple multimedia channels via one or more multimedia output path and one or more audio output path in any combination based on output selection criteria;
a multimedia signal processor configured to receive multiple multimedia signals corresponding to the multiple multimedia channels from the receiver, to demodulate modulated portions of each of the multiple multimedia signals, to decode encoded portions of each of the multiple multimedia signals, and to separate the audio and video content of each of the multiple multimedia signals to form corresponding audio and video signals;
an audio signal processor configured to receive the audio signal for each of the multiple multimedia channels from the multimedia signal processor and to condition each audio signal to form a corresponding conditioned audio signal; and
a wireless transmitter configured to receive the conditioned audio signal for one or more select multimedia channel of the multiple multimedia channels based on the output selection criteria, to perform at least one of modulating and encoding of the conditioned audio signal for each select multimedia channel to form a corresponding audio transmission signal, and to wirelessly transmit each audio transmission signal via at least one select output path of the one or more audio output path based on the output selection criteria.

8. The apparatus of claim 7 wherein the receiver, multimedia signal processor, audio signal processor, and wireless transmitter of the apparatus are combined in a set top box (STB), a set top unit, a digibox, a net top box, a converter box, a cable television (TV) box, an internet protocol TV (IPTV) box, or a satellite TV receiver.

9. The apparatus of claim 7 wherein at least one select multimedia channel distributed via the one or more audio output path is not distributed via the one or more video output path.

10. The apparatus of claim 7 wherein the output selection criteria relates the multiple multimedia channels to the multimedia and audio output paths and defines the combination for each of the multiple multimedia channels.

11. The apparatus of claim 7, further comprising:
a video signal processor configured to receive the video signal for each of the multiple multimedia channels from the multimedia signal processor and to condition each video signal to form a corresponding conditioned video signal; and
a multimedia interface configured to receive the conditioned audio and video signals for one or more preselected multimedia channel of the multiple multimedia channels from the audio and video signal processors based on the output selection criteria and to distribute the conditioned audio and video signals for each preselected multimedia channel via at least one preselected output path of the one or more multimedia output path based on the output selection criteria.

12. The apparatus of claim 7 wherein the wireless transmitter includes a frequency modulation (FM) transmitter configured to transmit the audio transmission signal for at least one select multimedia channel, wherein each select output path for each multimedia channel transmitted by the FM transmitter is defined by an FM carrier frequency, wherein the output selection criteria identifies the FM carrier frequency for each select output path used by the FM transmitter.

13. A method for local distribution of multiple multimedia channels from a multimedia service provider, comprising:
selecting multiple multimedia channels from a plurality of multimedia channels for local distribution at a customer premises based on channel selection criteria, each multimedia channel carrying a multimedia signal with audio and video content, wherein the plurality of multimedia channels are offered by a multimedia service provider;
receiving multiple multimedia signals from the multimedia service provider at a receiver of an apparatus within the customer premises via an access network, wherein the received multiple multimedia signals correspond to the selected multiple multimedia channels, wherein the apparatus is configured to distribute the multiple multimedia channels via one or more multimedia output path and one or more audio output path in any combination based on output selection criteria;
processing the multiple multimedia signals to demodulate modulated portions of each of the multiple multimedia signals, to decode encoded portions of each of the multiple multimedia signals, and to separate the audio and video content of each of the multiple multimedia signals to form corresponding audio and video signals;
processing the audio signal for each of the multiple multimedia channels to condition each audio signal to form a corresponding conditioned audio signal;
receiving the conditioned audio signal for one or more select multimedia channel of the multiple multimedia channels at a wireless transmitter based on the output selection criteria;
performing at least one of modulating and encoding of the conditioned audio signal for each select multimedia channel to form a corresponding audio transmission signal; and
wirelessly transmitting each audio transmission signal from the wireless transmitter via at least one select output path of the one or more audio output path based on the output selection criteria.

14. The method of claim 13 wherein at least one select multimedia channel distributed via the one or more audio output path is not distributed via the one or more video output path.

15. The method of claim 13 wherein the output selection criteria relates the multiple multimedia channels to the multimedia and audio output paths and defines the combination for each of the multiple multimedia channels.

16. The method of claim 13, further comprising:
processing the video signal for each of the multiple multimedia channels to condition each video signal to form a corresponding conditioned video signal;
receiving the conditioned audio and video signals for one or more preselected multimedia channel of the multiple multimedia channels at a multimedia interface based on the output selection criteria; and
distributing the conditioned audio and video signals for each preselected multimedia channel via at least one preselected output path of the one or more multimedia output path based on the output selection criteria.

17. The method of claim 13 wherein the wireless transmitter includes a frequency modulation (FM) transmitter, the method further comprising:
transmitting the audio transmission signal for at least one select multimedia channel from the FM transmitter, wherein each select output path for each multimedia channel transmitted by the FM transmitter is defined by an FM carrier frequency, wherein the output selection criteria identifies the FM carrier frequency for each select output path used by the FM transmitter.

18. The method of claim 13 wherein the wireless transmitter includes at least one of a Bluetooth transmitter and a WiFi transmitter, the method further comprising:
transmitting the audio transmission signal for at least one select multimedia channel from the Bluetooth or WiFi transmitter, wherein each select output path for each multimedia channel transmitted by the Bluetooth or WiFi transmitter is defined by at least one destination address, wherein the output selection criteria identifies the at least one destination address for each select output path used by the Bluetooth or WiFi transmitter.

19. The method of claim 13, further comprising:
transmitting the audio transmission signal for each one or more select multimedia channel from the wireless transmitter via a transmission mode that includes a broadcast mode to compatible audio receiving devices within range of the wireless transmitter, a multicast mode to a group of local audio receiving devices, or a unicast mode to a select local audio receiving device, wherein the output selection criteria identifies the transmission mode for each select output path.

20. The method of claim 13, further comprising:
transmitting the audio transmission signal for each one or more select multimedia channel from the wireless transmitter via a transmission mode that includes at least one of a streaming audio mode, an AirPlay mode, an AirPlay Mirroring mode, an AirTunes mode, and a Play To mode to one or more compatible audio receiving devices within range of the wireless transmitter, wherein the output selection criteria identifies the transmission mode for each select output path.
